(19) United States
(12) Patent Application Publication
(10) Pub. No.: US 2002/0007893 A1
(43) Pub. Date: Jan. 24, 2002

(54) Method of producing tread for tire

(75) Inventors: Katsuto Koyama, Kodaira City (JP); Hisao Makino, Higashimurayama City (JP)

Correspondence Address: OLIFF & BERRIDGE, PLC, P.O. BOX 19928, ALEXANDRIA, VA, 22320, US

(73) Assignee: Bridgestone Corporation, Chuo-ku (JP)

(21) Appl. No.: 09/893,394

(22) Filed: Jun. 29, 2001

(30) Foreign Application Priority Data
Jul. 19, 2000 (JP) 2000-219191
May 25, 2001 (JP) 2001-156360

(51) Int. Cl. B29C 35/00

(52) U.S. Cl. 152/548; 156/123

(57) ABSTRACT

In a method of producing a tire tread provided with an electrically conductive layer arranged therein, an uncured high electrically conductive rubber ribbon for the formation of the electrically conductive layer is wound on a circumference of a tire material containing a high electrically conductive rubber layer as at least an outermost layer at a given height in a radial direction under the rotation of the tire material, and an uncured tread rubber is wound on the circumference of the tire material before or after the winding of the ribbon.

### BACKGROUND OF THE INVENTION

1. Field of the Invention

This invention relates to a method of producing a tread for a tire capable of sufficiently discharging static electricity generated in a vehicle to a road surface while making a rolling resistance of the tire small.

2. Description of Related Art

Recently, it is increasingly demanded to reduce a fuel consumption of a vehicle from a viewpoint of not only economical efficiency but also environmental protection, and also it is strongly required to further reduce a rolling resistance in a tire for the vehicle accompanied with such a demand.

In order to satisfy such a requirement, it is favorable to decrease energy loss resulted from a deformation of a tread during the running of the tire under loading. For this end, it tends to positively replace a greater part of carbon black having a high hysteresis loss unsuitable for reducing the rolling resistance, which is compounded in a tread rubber at a greater amount, with silica having a low hysteresis loss.

When a greater amount of silica is compounded by largely decreasing the amount of carbon black compounded in the tread rubber, however, a value of electric resistance in the tread rubber becomes higher and hence static electricity generated in the vehicle is hardly discharged to a road surface.

For ensuring the discharge property of the tread rubber, therefore, JP-A-2000-85316 and the like propose that an electrically conductive layer made of a high electrically conductive rubber and radially extending from a base tread rubber to a ground contact face of a tread having, for example, a cap and base structure is formed by press-fitting a high electrically conductive rubber into a cap tread rubber having a low electrical conductivity through a multilayer extruder, or by cutting a cap tread rubber shaped through a spinneret of an extruder and flowing a high electrically conductive agent into a space between cut faces.

And also, it is attempted to form an electrically conductive thin layer on a tread portion by applying a high electrically conductive agent to the tread portion over a whole surface thereof.

In the method of press-fitting the high conductive rubber into the low conductive car tread rubber through the multilayer extruder, there are problems that when the fitting position of the high electrically conductive rubber is changed in accordance with the form, size and the like of the cap tread rubber, it is required to change an internal shape of an extruding head, and it is difficult to design an extruding head for rendering the electrically conductive layer into adequate form and size.

In the method of flowing the high electrically conductive agent into the space between physically cut faces of an uncured cap tread rubber shaped through the spinneret, it is difficult to sufficiently prevent the adhering between the cut faces of the cap tread rubber prior to the flowing of the high electrically conductive agent. On the other hand, when the flowing of the high electrically conductive agent is carried out in the cap tread rubber after the curing, a fear of generating a breakage of the tread from the cut faces during the running of the tire under loading becomes higher.

When the electrically conductive thin layer is formed over the whole surface of the tread portion, since a ground contact face of the tread is worn during the running of the tire, such an electrically conductive thin layer is prematurely lost from the ground contact face of the tread.

### SUMMARY OF THE INVENTION

It is, therefore, an object of the invention to solve the aforementioned problems of the conventional techniques and to provide a method of producing a tread for a tire which can simply and rapidly form an electrically conductive layer having desired form, size and the like at a required position while making useless a special design of an extruding head and a change of an internal shape in the extruding head for the formation of the required electrically conductive layer and sufficiently removing a fear of generating breakage of a tread and the like at the position of the electrically conductive layer formed.

According to the invention, there is the provision of a method of producing a tread for a tire provided with an electrically conductive layer arranged in at least one of a widthwise middle portion and side faces of a tread rubber made from a low electrically conductive rubber so as to extend from a high electrically conductive rubber layer located at an inner peripheral side of the tread rubber to ground contact face of a tread, which comprises winding an uncured high electrically conductive rubber ribbon for the formation of the electrically conductive layer on a circumference of a tire material containing a high electrically conductive rubber layer as at least an outermost layer at a given height in a radial direction under the rotation of the tire material, and winding an uncured tread rubber on the circumference of the tire material before or after the winding of the ribbon.

According to the invention, when a core having an outer circumferential shape corresponding to an inner circumferential shape of a product tire is used as a rotating support, and when a tire building drum is used as a rotating support and rendered into a shaping posture expandedly deforming a carcass band, the tire material is comprised of an innerliner, a carcass and a belt successively laminated on an outer circumferential face of the rotating support. And also, when a belt-tread drum is used as a rotating support, the tire material is a belt stuck and shaped on an outer circumferential face of the drum. Furthermore, when a base tire for forming a retread tire is used as a rotating support, the tire material is comprised of the base tire itself and a cushion rubber layer (hereinafter referred to as a tread under-cushion rubber layer) arranged under a tread on an outer circumferential side of a belt of the base tire.

The tread under-cushion rubber layer may be added to the tire materials other than the base tire used as the rotating support. And also, when the tread has a cap-base structure, all of the above tire materials may selectively be provided with a base tread rubber layer.

In any case, at least one of the base tread rubber layer, tread undercushion rubber layer, coating rubber layer for belt cord and coating rubber layer for cords in a belt protection member is a high electrically conductive rubber layer compounded with a greater amount of carbon black.

Moreover, the high electrically conductive rubber is favorable to have a volume resistivity at 25° C. of not more than 10⁶ Ω·cm after the vulcanization. The rubber ribbon is preferable to be a continuous body shaped by an extrusion die, a roller die or the like and having a width of about 2-80 mm, preferably 5-30 mm and a thickness of about 0.2-7.0 mm.

According to the method of the invention, the electrically conductive layer having any form and size can simply, easily and rapidly be formed in an arbitrary position only by winding the high electrically conductive uncured rubber ribbon on the circumference of the tire material without using a special extrusion head or the like.

Although the uncured tread rubber made from the low electrically conductive rubber occupies the total thickness of the tread or is a cap tread rubber in the tread having a cap-base structure, it is wound on the circumference of the tire material before or after the winding of the high electrically conductive uncured rubber ribbon, whereby a tread can be shaped as is expected.

In the winding of the uncured tread rubber, a part of the uncured tread rubber may be wound on the circumference of the tire material before the winding of the high electrically conductive rubber ribbon and the remainder thereof may be wound after the winding of the rubber ribbon. In this way, the winding position of the rubber ribbon can accurately be specified and guided by a part of the previously arranged uncured tread rubber and hence an accidental change of the winding shape of the rubber ribbon or the like can effectively be prevented.

That is, by dividing the uncured tread rubber into two parts can smoothly, accurately and tightly be arranged the rubber ribbon in a given position between the two parts of the uncured tread rubber as compared with a case that the whole of the uncured tread rubber is wound before the winding of the rubber ribbon.

In the invention, the uncured tread rubber can be constructed by winding a low electrically conductive uncured rubber ribbon on the circumference of the tire material as a whole. Thus, the tread rubber can easily be formed in any form and size and hence the degree of freedom in the design of the electrically conductive layer such as position, form and the like can be more increased.

On the other hand, when the whole of the uncured tread rubber is an integral extrusion shaped body of a low electrically conductive uncured rubber and the electrically conductive layer is existent in a widthwise middle portion of the tread rubber, the shaping efficiency of the tread can be increased by winding such integral extrusion shaped body on the circumference of the tire material so as to arrange at both sides of the electrically conductive layer.

Further, when a part of the uncured tread rubber is the low electrically conductive uncured rubber ribbon wound on the circumference of the tire material and the remainder is the integral extrusion shaped body of the low electrically conductive uncured rubber, the aforementioned merits can simultaneously be established.

On the other hand, when a high electrically conductive uncured rubber ribbon for the formation of the electrically conductive layer is wound at a side face of the uncured tread rubber on an outermost layer of the tire material, e.g. a base tread rubber layer, a tread under-cushion rubber layer or a belt cord coating rubber layer made of a high electrically conductive rubber within a given height in the radial direction, the electrically conductive layer can more simply and rapidly be formed under a higher arranging accuracy as compared with a case that the electrically conductive layer is formed in the widthwise middle portion of the tread rubber.

Moreover, when the outermost layer of the tire material is a base tread rubber layer made of a high electrically conductive rubber and the uncured tread rubber provided with the electrically conductive layer is a cap tread rubber layer, if a layer located at an inner circumferential side of the bead tread rubber layer is a tread under-cushion rubber layer or a belt cord coating rubber layer made of a high electrically conductive rubber, the discharge of static electricity generated in the vehicle toward the road surface can be carried out more smoothly and rapidly.

In the tread having the above cap-base structure, even when the base tread rubber layer is made of the high electrically conductive rubber, if the high electrically conductive uncured rubber ribbon is wound in a height ranging from the tread under-cushion rubber layer or the belt cord coating rubber layer to the outer surface of the cap tread rubber layer in the radial direction, the same effects as mentioned above can be developed.

Furthermore, in the tread having the cap-base structure, when the high electrically conductive uncured rubber ribbon is wound from a side face of the base tread rubber layer made of the high electrically conductive rubber to a side face of the cap tread rubber layer in a given height in the radial direction, the arranging accuracy of the rubber ribbon can be increased under a simple tread structure and also the electrically conductive layer can be formed more simply and rapidly.

Moreover, when at least one of the base tread rubber layer made of the high electrically conductive rubber and the cap tread rubber layer made of the low electrically conductive rubber is formed by winding one or more kinds of uncured rubber ribbons on the tire material, the degree of freedom to the form, size, position and the like can be increased likewise the aforementioned winding of the ribbon and also the winding can be carried out in a higher accuracy. And also, the properties and the like in the same layer can properly changed by varying the kind of the uncured rubber ribbon to be wound.

On the other hand, when at least one of the above layers formed by winding one or more kinds of integral extrusion shaped bodies of uncured rubbers, the tread shaping efficiency can be improved likewise the aforementioned cases and also rubber properties and the like in the layers can be selected, if necessary.

### BRIEF DESCRIPTION OF THE DRAWINGS

The invention will be described with reference to the accompanying drawings, wherein:

FIG. 1 is a schematically side view illustrating an outline for carrying out the method of the invention;

FIG. 2 is a diagrammatically section view in a widthwise direction of a tread illustrating the formation of an embodiment of the electrically conductive layer according to the invention;

FIGS. 3a to 3d are diagrammatically partial section views of various embodiments of the electrically conductive layer according to the invention, respectively;

FIG. 4 is a diagrammatically section view in a widthwise direction of a tread illustrating a forming embodiment of the electrically conductive layer according to the invention in a tread having a cap-base structure; and

FIG. 5 is a diagrammatically section view in a widthwise direction of a tread illustrating another forming embodiment of the electrically conductive layer according to the invention in a tread having a cap-base structure.

### DETAILED DESCRIPTION OF THE INVENTION

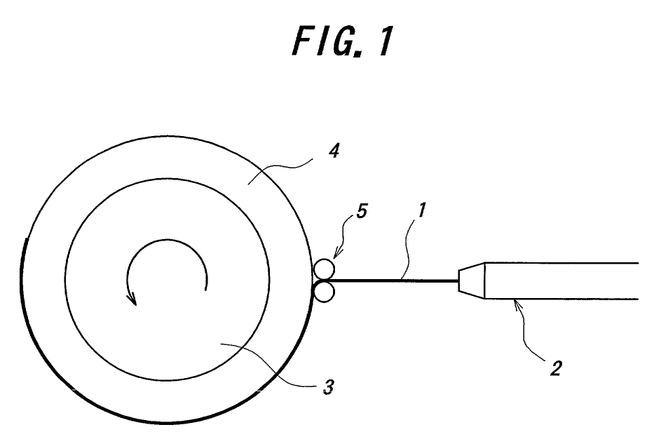

Referring to FIG. 1, an uncured rubber ribbon 1 is extruded and shaped through a die, a spinneret or the like of, for example, an extruder 2 as a continuous body of a rectangular shape having a width of about 1-80 mm and a thickness of 0.2-0.7 mm irrespectively of a high electrical conductivity or a low electrical conductivity. The thus formed continuous uncured rubber ribbon 1 is directly wound on an outer circumference of a rotating support 3 or indirectly wound thereon through a tire material 4 previously piled on the support under the rotation of the support and stuck thereon under a pushing action of rollers 5.

As the rotating support 3, there are a high rigidity core having an outer circumferential shape corresponding to an inner circumferential shape of a product tire, a tire building drum, particularly a tire building drum of such a shaping posture that a central portion of a carcass band stuck on a circumference of the drum is largely expanded and deformed in a radial direction, a belt-tread drum, a base tire for forming a retreading tire and so on.

As the tire material 4, there are a shaped body of an innerliner, a carcass and a belt successively laminated on the core or the tire building drum, a belt stuck on the belt-tread drum, and a base tire provided on its circumference with a tread under-cushion rubber layer for the retreading tire. And also, the tread under-cushion rubber layer may be adhered to an outer circumferential side of the belt.

Moreover, when the tread takes a cap-base structure, all of the above tire materials may be provided with a base tread rubber layer as an outermost layer.

In these tire materials 4, at least one of base tread rubber layer, tread under-cushion rubber layer, belt cord coating rubber layer and coating rubber layer for cords in a belt protection member is made of a high electrically conductive rubber.

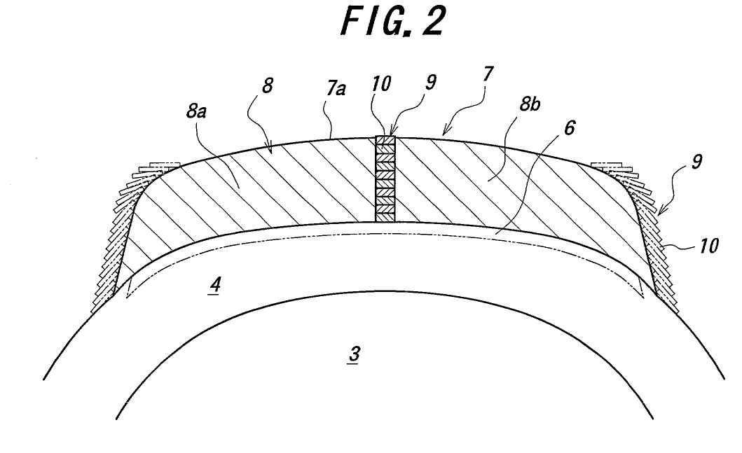

In FIG. 2 is shown an embodiment of forming the electrically conductive layer according to the invention, in which numeral 3 is one of the aforementioned rotating supports and numeral 4 one of the aforementioned tire materials. In the illustrated embodiment, the tire material 4 is provided with an uncured belt cord coating rubber layer 6 made of a high electrically conductive rubber as an outermost layer.

In this embodiment, a tread 7 is made of a low electrically conductive tread rubber 8 as a whole in its thickness direction. The tread 7 is provided on a widthwise middle portion, a substantially central portion in the illustrated embodiment with an electrically conductive layer 9 ranging from the belt cord coating rubber layer 6 located at an inner circumferential side of the tread 7 to a ground contact face 7a of the tread 7.

In order to realize the above structure shown in FIG. 2, a high electrically conductive uncured rubber ribbon 10 extruded and shaped as shown in FIG. 1 and having preferably a volume resistivity at 25° C. of not more than 106 Ω·cm is wound on a circumference of the tire material 4 at a given height in a radial direction under the rotation of the tire material 4 and hence the rotating support 3 before or after an uncured tread rubber 8 is wound on the circumference of the tire material 4, whereby the electrically conductive layer 9 is formed.

In the illustrated embodiment, the electrically conductive layer 9 is formed in substantially a normal direction of the tread 7 by helically winding and laminating the rubber ribbon 10 in the thickness direction. In this case, the windings of the rubber ribbon 10 contact with each other at their inside and outside over a full width of the ribbon, so that a large cross sectional area of the electrically conductive layer 9 can be ensured and hence a smooth discharge of static electricity passing through the electrically conductive layer 9 can be guaranteed.

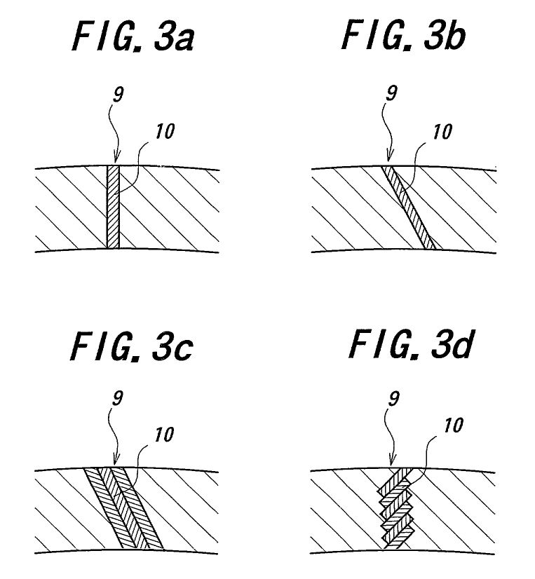

As shown in FIGS. 3a and 3b, the electrically conductive layer 9 may be formed by winding the rubber ribbon 10 on the tire material only one turn so as to extend the widthwise direction of the ribbon in substantially the normal direction of the tread 7 or incline somewhat with respect to the normal direction. In this case, the formation efficiency of the electrically conductive layer 9 can largely be increased.

And also, the electrically conductive layer 9 may be formed by spirally and continuously winding the rubber ribbon 10 inclined as shown in FIG. 3b in the widthwise direction of the tread plural turns so as to contact the windings in left and right directions with each other over the full width of the ribbon as shown in FIG. 3c. Even in this case, the guarantee of large cross sectional area and the improvement of the formation efficiency in the electrically conductive layer 9 can be established.

Furthermore, substantially the same effects as mentioned above can be attained even when the electrically conductive layer 9 is formed by winding and laminating the rubber ribbon 10 at a state of inclining the widthwise direction of the ribbon with respect to the normal direction of the tread 7 so as to contact the windings in a widthwise greater part with each other as shown in FIG. 3d. Moreover, the same effects as mentioned above can be attained when the electrically conductive layer 9 is formed by spirally winding the rubber ribbon 10 as shown in FIG. 3a in the widthwise direction of the tread 7 plural turns so as to contact the windings with each other over substantially the full width of the rubber ribbon 10 (not shown).

When the low electrically conductive uncured tread rubber 8 is wound on the tire material so as to leave a space corresponding to a position for the formation of the above electrically conductive layer 9 as shown in FIG. 2, the subsequent formation of the electrically conductive layer 9 can be carried out by winding and laminating the rubber ribbon 10 in the space of the tread rubber 8 while using such a space as a guide.

On the other hand, after the formation of the electrically conductive layer 9, the tread rubber 8 can be wound so as to arrange close to both side faces of the electrically conductive layer 9.

In any case, the electrically conductive layer 9 can be formed in the required given position with the required form and size. And also, the electrically conductive layer 9 can closely be united with the uncured tread rubber 8.

Alternatively, as shown in FIG. 2, a part of the uncured tread rubber 8, for example, portion 8a located at the left side of the electrically conductive layer 9 can be wound on the tire material before the formation of the electrically conductive layer 9, while the remaining portion 8b thereof can be wound on the tire material after the formation of the electrically conductive layer 9. According to this winding method, the formation of the electrically conductive layer 9 having structures as shown in FIGS. 3b to 3d becomes very easy.

As the structure of the tread 7 formed by winding the uncured tread rubber, there are a structure that the whole of the tread rubber 8 is formed by winding a low electrically conductive uncured rubber ribbon, e.g. a rubber ribbon having a rectangular form of about 5-30 mm in width and 0.2-7.0 mm in thickness on the tire material 4, and a structure that an integral extrusion shaped body of a low electrically conductive uncured rubber, e.g. an extrusion shaped body as a portion 8a of the tread rubber 8 and an extrusion shaped body as the remaining portion 8b are wound on the tire material 4 as shown in FIG. 2. In the former case, the degree of freedom in the design for the form, size and the like of the tread rubber can be increased and the dimensional accuracy and the like can be enhanced. In the latter case, the shaping efficiency of the tread can be improved.

Alternatively, the tread 7 is constructed on the tire material by winding the low electrically conductive uncured rubber ribbon as a portion 8a of the uncured tread rubber 8 and winding the integral extrusion shaped body of the low electrically conductive uncured rubber as the remaining portion 8b. In this case, the aforementioned merits can be simultaneously be established.

In addition to the forming embodiment of the electrically conductive layer 9, as shown by a phantom line in FIG. 2, the high electrically conductive uncured rubber ribbon 10 may be wound at a side face of the uncured tread rubber 8 within a required height ranging from the belt cord coating rubber layer 6 as an outermost layer of the tire material 4 to the ground contact face of the tread. In this case, the electrically conductive layer 9 can simply and rapidly be formed in a higher accuracy.

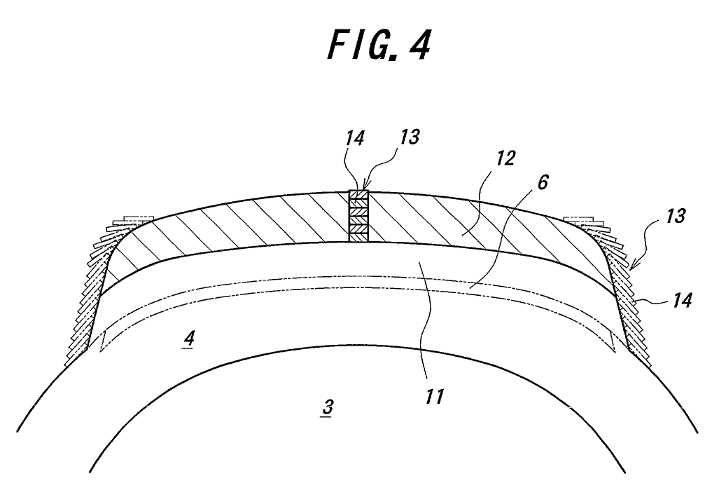

In FIG. 4 is sectionally shown a second embodiment of the tire according to the invention having a tread of a cap-base structure. In this case, an outermost layer of a tire material 4 is a high electrically conductive uncured base tread rubber layer 11 provided on its inner peripheral side with a belt cord coating rubber layer 6, while an uncured tread rubber made of a low electrically conductive rubber forms a cap tread rubber layer 12 located at an outer peripheral side of the base tread rubber layer 11, and an electrically conductive layer 13 extending from the base tread rubber layer 11 to a ground contact face of the tread is arranged in a widthwise central portion of the cap tread rubber layer 12. The electrically conductive layer 13 is formed by winding and laminating a high electrically conductive uncured rubber ribbon 14 in a thickness direction thereof likewise the case of FIG. 2.

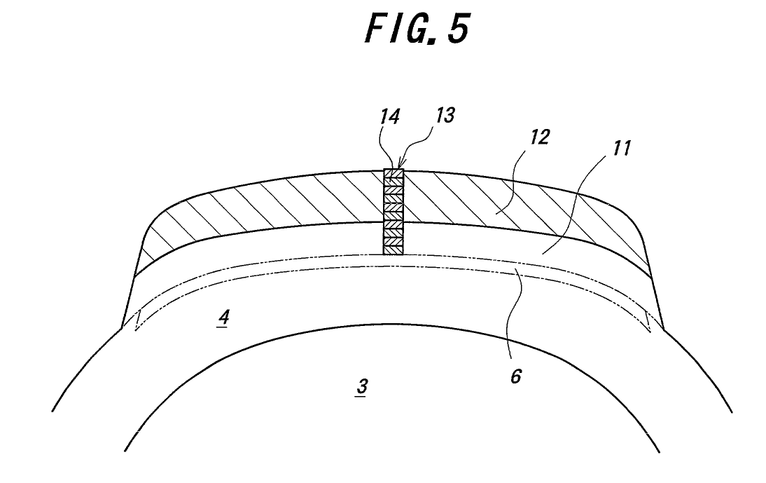

In FIG. 5 is sectionally shown a third embodiment of the tire according to the invention having a tread of a cap-base structure. In this case, the electrically conductive layer 13 is formed so as to extend from the surface of the belt cord coating rubber layer 6 through the base tread rubber layer 11 and the cap tread rubber layer 12 to the ground contact face of the tread in the radial direction.

Even in the treads having the above structures, as shown by a phantom line in FIG. 4, the electrically conductive layer 13 may be formed by winding the high electrically conductive uncured rubber ribbon 14 from a side face of the base tread rubber layer 11 through a side face of the cap tread rubber layer 12 to an outer surface of the cap tread rubber layer 12. In this case, the electrically conductive layer 13 may be extended to a position corresponding to the surface of the tire material 4.

In these embodiments of FIGS. 4 and 5, the electrically conductive layer 13 may be formed in various forms as shown in FIGS. 3a to 3d. And also, each of the base tread rubber layer 11 and the cap tread rubber layer 12 may be formed by winding the uncured tread rubber 8 as previously mentioned. In the latter case, at least one of the base tread rubber layer made of the high electrically conductive rubber and the cap tread rubber layer made of the low electrically conductive rubber may be formed by winding one or more kinds of uncured rubber ribbons or one or more kinds of uncured rubber extrusion shaped bodies.

As mentioned above, according to the invention, the electrically conductive layer having a form, a size and the like as expected can simply and rapidly be formed by winding a high electrically conductive uncured rubber ribbon, so that a special design of an extruding head and a change of an internal shape in the extruding head for the formation of the required electrically conductive layer are made useless for integrally forming the electrically conductive layer having a desired form with the tread rubber, and also a fear of generating adhesion between cut faces when the uncured tread rubber is cut and the electrically conductive layer is formed between the cut faces and when the electrically conductive layer is formed between the cured tread rubbers and a fear of generating a breakage of a tread and the like at the cut face can completely be removed.

What is claimed is:

1. A method of producing a tread for a tire provided with an electrically conductive layer arranged in at least one of a widthwise middle portion and side faces of a tread rubber made from a low electrically conductive rubber so as to extend from a high electrically conductive rubber layer located at an inner peripheral side of the tread rubber to ground contact face of a tread, which comprises winding an uncured high electrically conductive rubber ribbon for the formation of the electrically conductive layer on a circumference of a tire material containing a high electrically conductive rubber layer as at least an outermost layer at a given height in a radial direction under the rotation of the tire material, and winding an uncured tread rubber on the circumference of the tire material before or after the winding of the ribbon.

2. The method according to claim 1, wherein a part of the uncured tread rubber is wound on the circumference of the tire material before the winding of the high electrically conductive uncured rubber ribbon and the remaining portion thereof is wound after the winding of the ribbon.

3. The method according to claim 1, wherein a whole of the uncured tread rubber is constructed by winding a low electrically conductive uncured rubber ribbon on the circumference of the tire material.

4. The method according to claim 1, wherein a whole of the uncured tread rubber is constructed by winding an integral extrusion shaped body of a low electrically conductive uncured rubber on the circumference of the tire material.

5. The method according to claim 1, wherein a part of the uncured tread rubber is constructed by winding a low electrically conductive uncured rubber ribbon on the circumference of the tire material and the remaining portion thereof is constructed by winding an integral extrusion shaped body of a low electrically conductive uncured rubber on the circumference of the tire material.

6. The method according to claim 1, wherein the high electrically conductive uncured rubber ribbon forming the electrically conductive layer is wound at a side face of the uncured tread rubber within a given height from the outermost layer of the tire material in the radial direction.

7. The method according to claim 1, wherein the outermost layer of the tire material is a tread under-cushion rubber layer or a belt cord coating rubber layer.

8. The method according to claim 1, wherein the outermost layer of the tire material is a base tread rubber layer and the uncured tread rubber forms a cap tread rubber layer, and a layer located at an inner circumferential side of the outermost layer is a tread under-cushion rubber layer or a belt cord coating rubber layer or a cord coating rubber layer for a belt protection member made of a high electrically conductive rubber.

9. The method according to claim 8, wherein the high electrically conductive uncured rubber ribbon forming the electrically conductive layer is wound from the tread under-cushion rubber layer or the belt cord coating rubber layer or the cord coating rubber layer for the belt protection member made of the high electrically conductive rubber in a height arriving at a surface of the cap tread rubber layer in the radial direction.

10. The method according to claim 8, wherein the high electrically conductive uncured rubber ribbon forming the electrically conductive layer is wound at side faces of the base tread rubber layer and the cap tread rubber layer in a given height in the radial direction.

11. The method according to claim 8, wherein at least one of the base tread rubber layer made of a high electrically conductive rubber and the cap tread rubber layer made of a low electrically conductive rubber is constructed by winding one or more kinds of uncured rubber ribbons or one or more kinds of uncured rubber extrusion shaped bodies on the tire material.
